(19) United States
(12) Patent Application Publication
(10) Pub. No.: US 2024/0405827 A1
(43) Pub. Date: Dec. 5, 2024

(54) PRIORITIZATION MECHANISM FOR SRS ANTENNA PORT SWITCHING

(71) Applicant: APPLE INC., Cupertino, CA (US)

(72) Inventors: Jie Cui, San Jose, CA (US); Dawei Zhang, Saratoga, CA (US); Hong He, San Jose, CA (US); Huaning Niu, San Jose, CA (US); Manasa Raghavan, Sunnyvale, CA (US); Qiming Li, Beijing (CN); Seyed Ali Akbar Fakoorian, San Diego, CA (US); Xiang Chen, Campbell, CA (US); Yang Tang, San Jose, CA (US); Yushu Zhang, Beijing (CN)

(21) Appl. No.: 18/697,335

(22) PCT Filed: Oct. 8, 2021
(86) PCT No.: PCT/CN2021/122701

§ 371 Date: Mar. 29, 2024

(51) Int. Cl. H04B 7/06; H04B 17/318; H04W 72/21

(52) U.S. Cl. CPC H04B 7/0626; H04B 17/328; H04W 72/21

(57) ABSTRACT

Systems and methods for networks having user equipment (UE) that can perform measurement/reporting of received signals and a sounding reference signal (SRS) transmission that is part of an SRS antenna port switching procedure are described herein. In some circumstances, the measurement and the SRS antenna port switching procedure overlap on one or more symbols. Across various embodiments, the UE prioritizes one of the measurement and the SRS antenna port switching procedure based on one or more of a scheduling type (periodic, semi-persistent, aperiodic) of the measurement, a scheduling type of a channel state information (CSI) report for a measurement result for the measurement, and/or a scheduling type of the SRS transmission of the SRS antenna port switching procedure. Networks that avoid overlaps by scheduling SRS transmissions away from UE signal measurements, or transmissions of signals to be measured away from UE SRS antenna port switching procedures, are also described.

### TECHNICAL FIELD

This application relates generally to wireless communication systems, including such systems where UEs can perform both measurement/reporting of received signals and sounding reference signal (SRS) antenna port switching with an SRS transmission.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table detailing a correspondence between possibilities for configuring a scheduling type for a CSI-RS measurement and a scheduling type for an associated CSI report for each of those possibilities, according to an embodiment.

FIG. 2A and FIG. 2B together illustrate a table that synthesizes possibilities for measurement signal scheduling types of various signals (e.g., CSI-RS, SSB) used for measurement, corresponding possible CSI report scheduling types for CSI reports reporting measurement results generated using those signals, and corresponding SRS transmission scheduling types for SRS transmissions of SRS antenna port switching procedures that may overlap with those signals.

FIG. 3 illustrates a table summarizing various possible prioritizations according to possible combinations of scheduling types for a CSI-RS measurement and scheduling types for an SRS transmission when applying a first option.

FIG. 4 illustrates a method of a UE, according to an embodiment.

FIG. 5 illustrates a table summarizing various possible prioritizations according to possible combinations of scheduling types for a CSI-RS measurement, scheduling types for a CSI report, and scheduling types for an SRS transmission when applying a second option.

FIG. 6 illustrates a method of a UE, according to an embodiment.

FIG. 7 illustrates a table summarizing various possible prioritizations according to possible combinations of scheduling types for a CSI-RS measurement, scheduling types for a CSI report, and scheduling types for an SRS transmission when applying a third option.

FIG. 8 illustrates a table summarizing various possible prioritizations according to possible combinations of scheduling types for CSI-RS measurement, scheduling types for a CSI report, and scheduling types for an SRS transmission when applying a fourth option.

FIG. 9 illustrates a method of a UE, according to an embodiment.

FIG. 10 illustrates a table summarizing various possible prioritizations according to possible combinations of an SSB measurement resource and scheduling types for an SRS transmission when applying a fifth option.

FIG. 11 illustrates a method 1100 of a UE, according to an embodiment.

FIG. 12 illustrates a table summarizing various possible prioritizations according to possible combinations of an SSB measurement resource, scheduling types for a CSI report, and scheduling types for an SRS transmission when applying a sixth option.

FIG. 13 illustrates a method of a UE, according to an embodiment.

FIG. 14 illustrates a method of a wireless communication network, according to an embodiment.

FIG. 15 illustrates a method of a wireless communication network, according to an embodiment.

FIG. 16 illustrates an example architecture of a wireless communication system, according to embodiments disclosed herein.

FIG. 17 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A UE may be configured to use a sounding reference signal (SRS) antenna port switching procedure. A UE may perform an SRS antenna port switching procedure by tuning away from a first antenna port being used and tuning to a second antenna port, sending a scheduled SRS transmission for the second antenna port on the second antenna port, and/or tuning back to the first antenna port. Such an SRS antenna port switching procedure accordingly facilitates the sending of an SRS on a desired antenna port, even in the case that that antenna port is not presently in active use by the UE. The associated SRS transmission can accordingly be used by a base station to sound or otherwise evaluate the channel according to the antenna port (again, even though that antenna port is not (otherwise) in active use by the UE).

An SRS transmission may be scheduled periodically, semi-persistently, or aperiodically. For a periodic SRS transmission, an SRS may be sent by the UE periodically according to a configuration. In such a case, it is accordingly understood that the scheduling type of the SRS transmission is periodic. For a semi-persistent SRS transmission, an SRS may be sent by the UE periodically according to a configuration and when such behavior is explicitly enabled. In such a case, it is accordingly understood that the scheduling type of the SRS transmission is semi-persistent. For an aperiodic SRS transmission, an SRS may be sent by the UE based on a dynamic trigger. In such a case, it is accordingly understood that the scheduling type of the SRS transmission is aperiodic. It is contemplated that SRS antenna port switching procedure as described herein may be used with any of a periodic SRS transmission, a semi-static SRS transmission, and/or an aperiodic SRS transmission.

It may be that the UE can (also) be scheduled to perform a measurement (e.g., a Layer-1 reference signal received power (L1-RSRP) measurement or a Layer-1 signal to interference and noise ratio (L1-SINR) measurement) of a downlink (DL) signal (e.g., a channel state information reference signal (CSI-RS) or a synchronization signal block (SSB)) during one or more symbols, and to send a channel state information (CSI) report having measurement results from such a measurement to, for example, a base station of the network.

It may be that in some wireless communications systems where a UE is operating in an NR standalone (NR-SA), the UE does not prioritize (e.g., disables) an SRS antenna port switching procedure when it overlaps with one or more symbols of a Layer-3 (L3) measurement, a radio link monitoring (RLM) procedure, beam failure detection (BFD) procedure, and/or candidate beam detection (CBD) procedure. In some wireless communications systems where a UE operates in an evolved-universal terrestrial radio access-new radio dual connectivity (EN-DC) mode, the UE does not prioritize (e.g., disables) an SRS antenna port switching procedure when it overlaps with one or more symbols of an L3 measurement, an RLM procedure, a BED procedure, and/or a CBD procedure in a secondary cell group (SCG). In some wireless communications system where a UE operates in a new radio-evolved-universal terrestrial radio access dual connectivity (NE-DC) mode, the UE does not prioritize (e.g., disables) an SRS antenna port switching procedure when it overlaps with one or more symbols of an L3 measurement, an RLM procedure, a BFD procedure, and/or a CBD procedure in a master cell group (MCG). In some wireless communications systems where a UE operates in a new radio dual connectivity (NR-DC) mode, the UE does not prioritize (e.g., disables) an SRS antenna port switching procedure when it overlaps with one or more symbols of an L3 measurement, an RLM procedure, a BFD procedure, and/or a CBD procedure in a cell group (CG). However, such systems may not deterministically handle the case of an overlap between an SRS antenna port switching procedure and, for example, a Layer-1 reference signal received power (L1-RSRP) measurement or a Layer-1 signal to interference and noise ratio (L1-SINR) measurement).

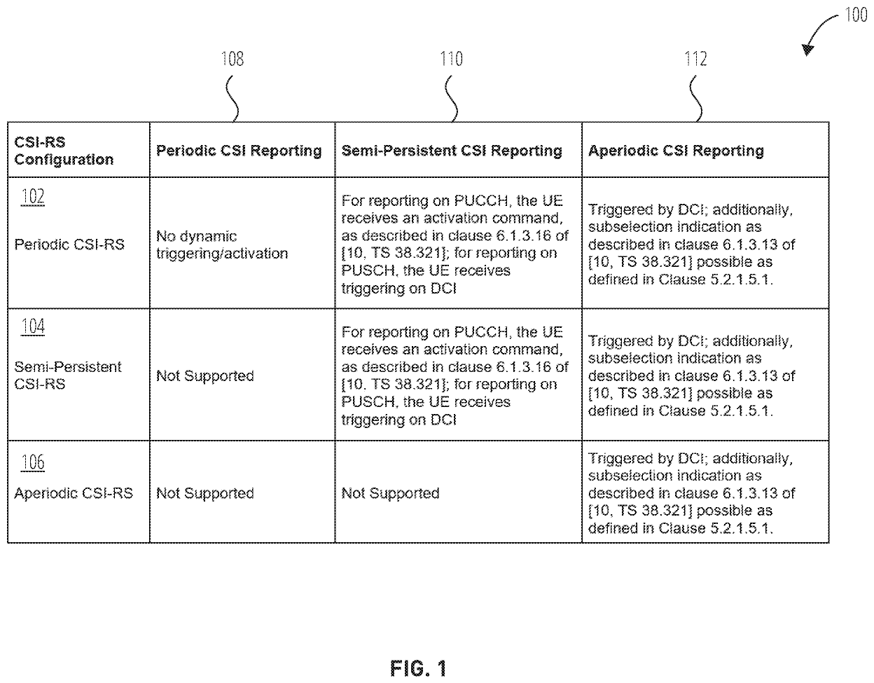

FIG. 1 illustrates a table 100 detailing a correspondence between possibilities for configuring a scheduling type for a CSI-RS measurement and a scheduling type for an associated CSI report for each of those possibilities, according to an embodiment. The table 100 includes correspondence information for each of a periodic CSI-RS 102, a semi-persistent CSI-RS 104, and an aperiodic CSI-RS 106. For a periodic CSI-RS 102, a CSI-RS may be sent by a base station and measured at the IE periodically according to a configuration. In such a case, it is accordingly understood that the scheduling type of the CSI-RS measurement is periodic. For a semi-persistent CSI-RS 104 a CSI-RS may be sent by the base station and measured by the UE periodically according to a configuration and when such behavior is explicitly enabled. In such a case, it is accordingly understood that the scheduling type of the CSI-RS measurement is semi-persistent. For an aperiodic CSI-RS 106, a CSI-RS may be sent by the base station and measured by the UE based on a dynamic trigger. In such a case, it is accordingly understood that the scheduling type of the CSI-RS measurement is aperiodic.

In some systems, it may be that a measurement result generated using a CSI-RS measurement can be reported using one of periodic CSI reporting 108, semi-persistent CSI reporting 110, and/or aperiodic CSI reporting 112. For periodic CSI reporting 108, it may be that a CSI report for the measurement result is sent according to a periodic configuration for sending CSI reports. In such a case, it is accordingly understood that a scheduling type of the CSI report is periodic. For a semi-persistent CSI reporting 110, it may be that a CSI report for the measurement result is sent according to a periodic configuration for sending CSI reports and when such behavior is explicitly enabled. In such a case, it is accordingly understood that the scheduling type of the CSI report is semi-persistent. For aperiodic CSI reporting 112, it may be that a CSI report for the measurement result is sent according to a dynamic trigger. In such a case, it is accordingly understood that the scheduling type of the CSI report is aperiodic.

Then, the table 100 illustrates that to send a CSI report having a measurement result corresponding to a measurement of a periodic CSI-RS 102, periodic CSI reporting 108, semi-persistent CSI reporting 110, or aperiodic CSI reporting 112 as described herein may be used. The table 100 further illustrates that to send a CSI report having a measurement result corresponding to a measurement of a semi-persistent CSI-RS 104, semi-persistent CSI reporting 110 or aperiodic CSI reporting 112 may be used. The table 100 further illustrates that to send a CSI report having a measurement result corresponding to a measurement of an aperiodic CSI-RS 106, aperiodic CSI reporting 112 may be used. Discussion herein regarding the measurement of and reporting of CSI-RS may assume such restrictions as between a scheduling type of a CSI-RS measurement and a scheduling type of a corresponding CSI report.

In some systems, it may be that a measurement result generated using an SSB measurement can be reported using one of periodic CSI reporting, semi-persistent CSI reporting, and/or aperiodic CSI reporting. Thus, a CSI report of a corresponding scheduling type (a periodic scheduling type, semi-persistent scheduling type, and/or an aperiodic scheduling type, as these have been previously described) may accordingly be used to report the measurement result generated using the SSB. Note that due to the periodic nature of SSB reception (and thus SSB measurement), it may be that a scheduling type for an SSB measurement is considered to be periodic. Accordingly, any of periodic CSI reporting, semi-persistent CSI reporting, and/or aperiodic CSI reporting can be used relative to the SSB measurement, as described. A CSI report may be sent on, for example, a physical uplink control channel (PUCCH) or a physical uplink shared channel (PUSCH)

In some circumstances, it may be that a UE is scheduled to perform a measurement (e.g., using a CSI-RS or SSB, as described above) during one or more symbols that are overlapped (at least in part) with one or more symbols covered by an SRS antenna port switching procedure associated with a scheduled SRS transmission. An overlap (or collision) may occur when the same one or more symbols on the same carrier are scheduled to be used for at least part of the measurement and at least part of the SRS antenna port switching procedure.

An overlap can also occur relative to corresponding one or more symbols found on each of a first carrier for the SRS transmission of the SRS antenna port switching procedure and a second carrier for the measurement (e.g., the CSI-RS measurement or SSB measurement), in the case that a cross-carrier impact parameter indicates that a use of the first carrier for the SRS transmission will impact an ability of the UE to use the second carrier for DL reception (e.g., in order to perform the measurement). One example of a cross-carrier impact parameter that may provide such an indication is a ‘txSwitchImpactToRx’ UE capability parameter (e.g., as discussed in 3GPP TS 38.306 version 16.6.0 (September 2021), section 4.2.7.1). In such cases, it may be that in some circumstances the carrier for the measurement is in a same cell group as the carrier for the SRS transmission of the SRS antenna port switching procedure. This may be the case when the UE is operating in an EN-DC mode, an NE-DC mode, an NR carrier aggregation (CA) mode, or a NR-DC mode. In other circumstances, the carrier for the measurement is in a different cell group from the carrier for the SRS transmission of the SRS antenna port switching procedure. This may be the case when the UE is operating in an NR-DC mode.

In cases involving this type of overlap, where a capability of the UE will only allow for one of the measurement and the SRS antenna port switching procedure to be performed at the UE (e.g., where the UE cannot or is not configured to perform both the SRS antenna port switching procedure and the measurement simultaneously due to their overlapped nature), it may be desirable to prioritize one of the measurement and the SRS antenna port switching procedure. Then, a prioritized one of the measurement and the SRS antenna port switching procedure can be performed (and a non-prioritized one of the measurement and the SRS antenna port switching procedure may be disabled).

It may be beneficial to determine such a prioritized one of the measurement and the SRS antenna port switching procedure in a deterministic fashion. This may allow the UE to comply with a communications system standard (e.g., that defines the manner of determining this priority) such that the ultimate behavior of the UE (according to the prioritization) is as expected by a communication system (e.g., network) implementing the communications system standard, thereby facilitating the use of the UE with the communication system.

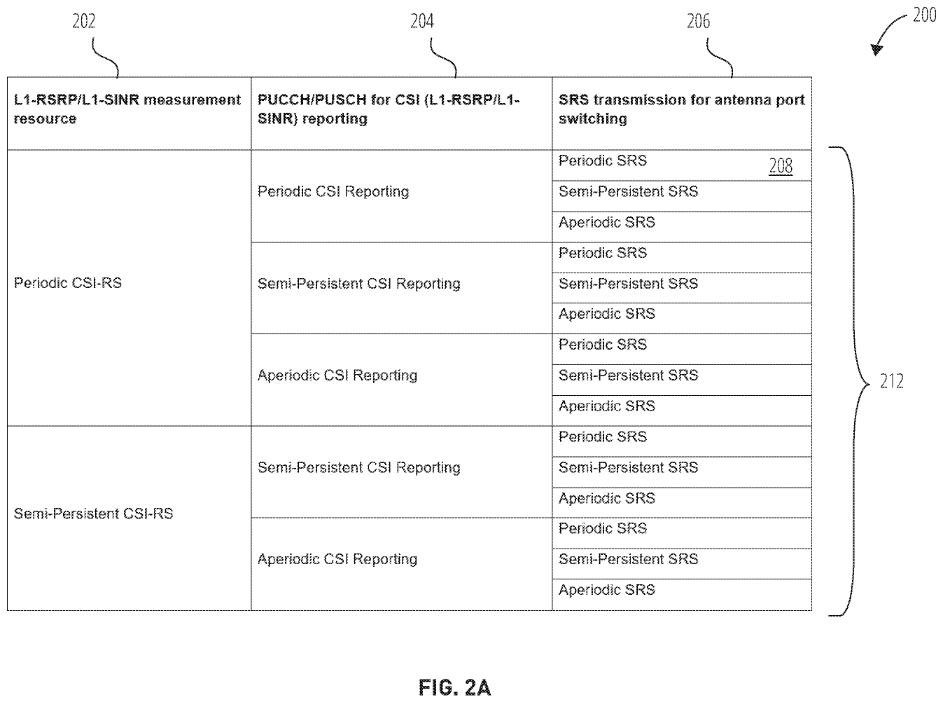

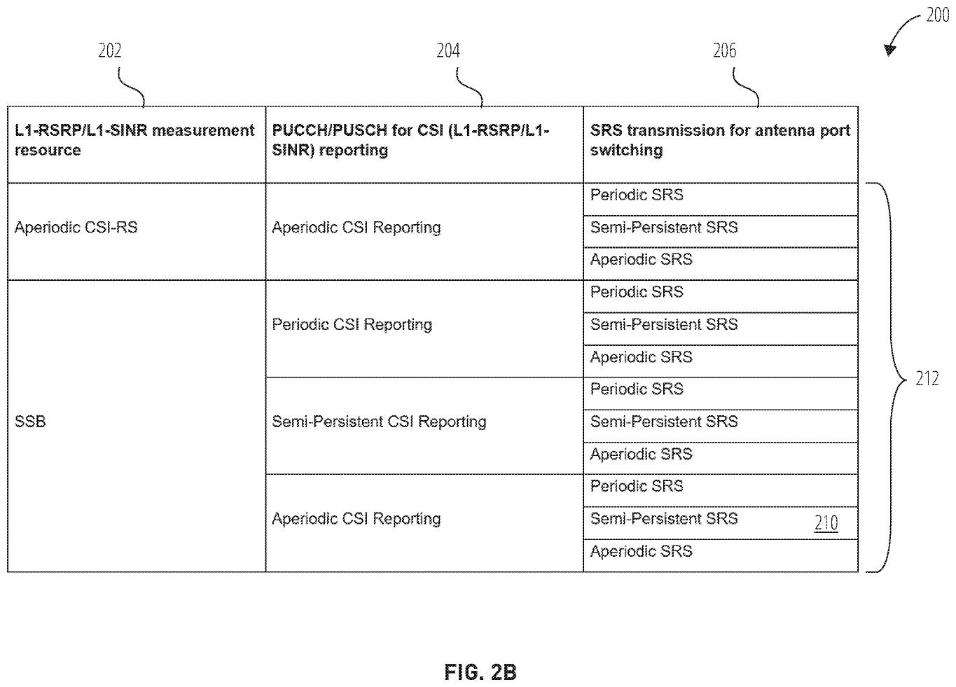

In such cases (where the measurement and the SRS antenna port switching procedure overlap), it is contemplated that the selection of the prioritized one of the measurement and the SRS antenna port switching procedure may be made in view of one or more of a scheduling type of a CSI-RS measurement, a scheduling type for a CSI report for the CSI-RS measurement, and/or a scheduling type of the SRS transmission of the SRS antenna port switching procedure. FIG. 2A and FIG. 2B together illustrate a table 200 that synthesizes possibilities 212 for measurement signal scheduling types 202 of various signals (e.g., CSI-RS, SSB) used for measurement, corresponding possible CSI report scheduling types 204 for CSI reports reporting measurement results generated using those signals, and corresponding SRS transmission scheduling types 206 for SRS transmissions of SRS antenna port switching procedures that may overlap with those signals. For example, a first possibility 208 involves the measurement of a CSI-RS. In the first possibility 208, a scheduling type of the CSI-RS measurement is periodic, a scheduling type of a CSI report for measurement results of the CSI-RS measurement is periodic, and a scheduling type of an SRS transmission of an SRS antenna port switching procedure that overlaps with the CSI-RS measurement is periodic. As another example, a twenty-sixth possibility 210 involves the measurement of an SSB (where SSB measurements may be considered to have a scheduling type that is periodic, as described previously). In the twenty-sixth possibility 210, a scheduling type of a CSI report for measurement results of the SSB measurement is aperiodic, and a scheduling type of an SRS transmission of an SRS antenna port switching procedure that overlaps with the CSI-RS measurement is semi-persistent.

Various options for selecting a prioritized one of a measurement and an SRS antenna port switching procedure in cases where these items overlap are described herein. It may be the case that for each of these described options, the UE behavior may be understood to tend to prioritize the SRS antenna port switching procedure. This may reflect the understanding that uplink (UL) resources (e.g., on which an SRS transmission of the SRS antenna port switching procedure may be sent) may tend to be more limited than DL resources (e.g., that can be used to provide the signal on which the measurement is performed at the UE) within the wireless communication system as a general matter. However, in at least some of the described options, circumstances may exist where it is desirable for the UE to instead prioritize the measurement over the SRS antenna port switching procedure (when certain conditions are met, as will be shown).

A first option for selecting a prioritized one of a measurement and an SRS antenna port switching procedure is now described. The first option contemplates that the measurement is a CSI-RS measurement. The first option determines a prioritization between the CSI-RS measurement and an overlapped SRS antenna port switching procedure based (at least in part) on a scheduling type of the CSI-RS measurement. It is further contemplated that the first option may disregard (e.g., not take into account) a scheduling type for a CSI report for the CSI-RS measurement.

Cases where it is determined to prioritize a CSI-RS measurement over an SRS antenna port switching procedure as will be described for the first option may reflect the idea that if the CSI-RS measurement a has an aperiodic scheduling type, it may not be able to be performed at a later time (because no such time is inherently available corresponding to such aperiodic use). Further, if it is (also) the case that the SRS antenna port switching procedure is of a scheduling type that is periodic or semi-persistent, it is likely that a subsequent opportunity for it will arise. In view of these considerations, the CSI-RS measurement that is of an aperiodic scheduling type may prioritized.

In cases according to the first option where both a scheduling type of the CSI-RS measurement is aperiodic and the scheduling type for the SRS transmission of the SRS antenna port switching procedure is aperiodic, the UE may be (pre)configured to prioritize either the CSI-RS measurement or the SRS antenna port switching procedure, or it may prioritize one of the CSI-RS measurement and the SRS antenna port switching procedure according to a dynamic network indication.

In a first case of the first option, it may be that a scheduling type of the CSI-RS measurement is periodic or semi-persistent. Further, a scheduling type of the SRS transmission of the overlapped SRS antenna port switching procedure is any of periodic, semi-persistent, or aperiodic. In this first case, the UE would prioritize the SRS antenna port switching procedure over the CSI-RS measurement. Accordingly, the UE would perform the SRS antenna port switching procedure and disable the CSI-RS measurement.

In a second case of the first option, it may be that a scheduling type of the CSI-RS measurement is aperiodic. Further, a scheduling type of the SRS transmission of the overlapped SRS antenna port switching procedure is periodic or semi-persistent. In this first case, the UE would prioritize the CSI-RS measurement over the SRS antenna port switching procedure. Accordingly, the UE, would perform the CSI-RS measurement and disable the SRS antenna port switching procedure.

In a third case of the first option, it may be that a scheduling type of the CSI-RS measurement is aperiodic. Further, a scheduling type of the SRS transmission of the overlapped SRS antenna port switching procedure is also aperiodic.

In a first alternative of this third case, the UE would prioritize the SRS antenna port switching procedure over the CSI-RS measurement. Accordingly, the UE would perform the SRS antenna port switching procedure and disable the CSI-RS measurement.

In a second alternative of this third case, the UE would prioritize the CSI-RS measurement over the SRS antenna port switching procedure. Accordingly, the UE would perform the CSI-RS measurement and disable the SRS antenna port switching procedure.

In a third alternative of this third case, it may be that the UE determines to prioritize either the CSI-RS measurement or the SRS antenna port switching procedure based on a network indication (e.g., provided from a base station). The UE would then perform the prioritized one of the CSI-RS measurement and the SRS antenna port switching procedure and disable the non-prioritized one of the CSI-RS measurement and the SRS antenna port switching procedure. The network indication may be received in one of downlink control information (DCI), a medium access control control element (MAC CE), or radio resource control (RRC) signaling.

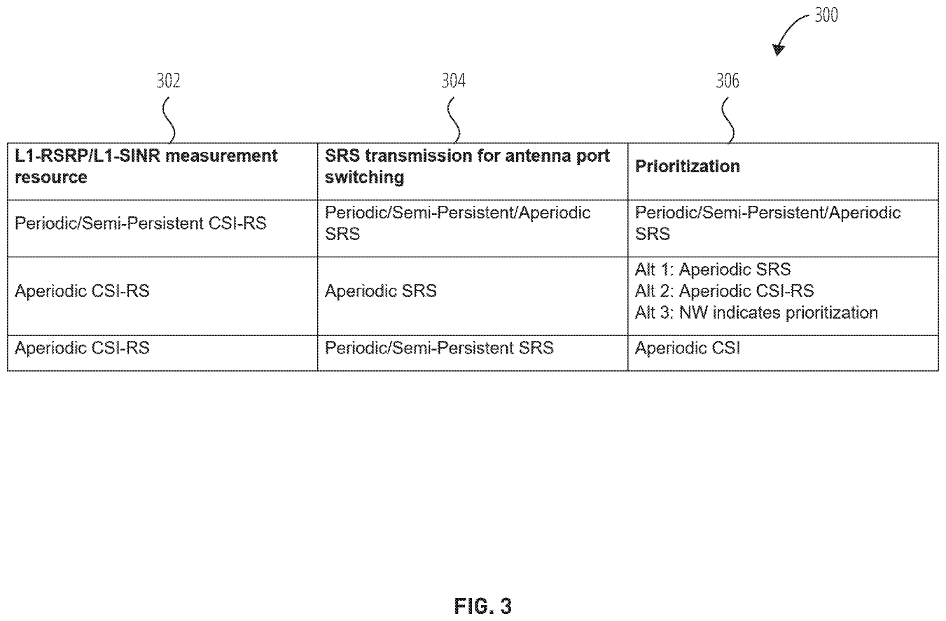

FIG. 3 illustrates a table 300 summarizing various possible prioritizations 306 according to possible combinations of scheduling types for a CSI-RS measurement 302 and scheduling types for an SRS transmission 304 when applying the first option, as these have been described above.

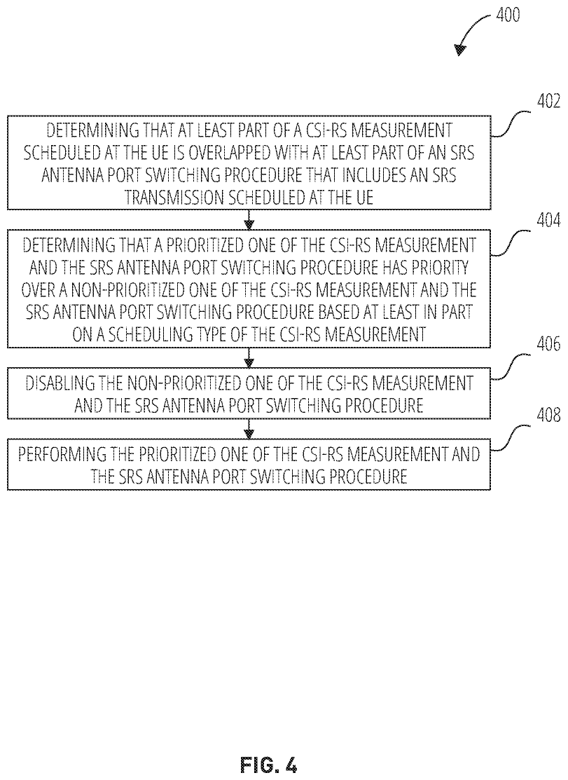

FIG. 4 illustrates a method 400 of a UE, according to an embodiment. The method 400 includes determining 402 that at least part of a CSI-RS measurement scheduled at the UE is overlapped with at least part of an SRS antenna port switching procedure that includes an SRS transmission scheduled at the UE.

The method 400 further includes determining 404 that a prioritized one of the CSI-RS measurement and the SRS antenna port switching procedure has priority over a non-prioritized one of the CSI-RS measurement and the SRS antenna port switching procedure based at least in part on a scheduling type of the CSI-RS measurement.

The method 400 further includes disabling 406 the non-prioritized one of the CSI-RS measurement and the SRS antenna port switching procedure.

The method 400 further includes performing 408 the prioritized one of the CSI-RS measurement and the SRS antenna port switching procedure.

In some embodiments of the method 400, the UE determines that the SRS antenna port switching procedure is the prioritized one when the scheduling type of the CSI-RS measurement is one of periodic and semi-persistent.

In some embodiments of the method 400, the UE determines that the CSI-RS measurement is the prioritized one when the scheduling type of the CSI-RS measurement is aperiodic and when a scheduling type of the SRS transmission is one of periodic and semi-persistent.

In some embodiments of the method 400, the UE determines that the SRS antenna port switching procedure is the prioritized one when the scheduling type of the CSI-RS measurement is aperiodic and a scheduling type of the SRS transmission is aperiodic.

In some embodiments of the method 400, the UE determines that the CSI-RS measurement is the prioritized one when the scheduling type of the CSI-RS measurement is aperiodic and a scheduling type of the SRS transmission is aperiodic.

In some embodiments of the method 400, the UE determines the prioritized one of the CSI-RS measurement and the SRS antenna port switching procedure according to a network indication when the scheduling type of the CSI-RS measurement is aperiodic and a scheduling type of the SRS transmission is aperiodic. In some of these embodiments, the network indication is provided in one of DCI, a MAC CE, and RRC signaling.

In some embodiments of the method 400, the SRS antenna port switching procedure further includes one or more transient periods for performing antenna port switching.

In some embodiments of the method 400, a CSI report for the CSI-RS measurement is scheduled to be sent in one of a PUCCH and a PUSCH.

In some embodiments of the method 400, the CSI-RS measurement comprises one of an L1-RSRP measurement and an L1-SINR measurement.

In some embodiments of the method 400, the CSI-RS measurement and the SRS transmission are for a same carrier.

In some embodiments of the method 400, the SRS transmission is for a first carrier and the CSI-RS measurement is for a second carrier, and a cross-carrier impact parameter indicates that a use of the first carrier for the SRS transmission impacts an ability of the UE to use the second carrier for DL reception. In some of these embodiments, the first carrier and the second carrier are in a same cell group. In some of these embodiments, the first carrier is in a first cell group and the second carrier is in a second cell group.

Embodiments contemplated herein include an apparatus comprising means to perform one or more elements of the method 400. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 400. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 1702 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

A second option for selecting a prioritized one of a measurement and an SRS antenna port switching procedure is now described. The second option contemplates that the measurement is a CSI-RS measurement. The second option determines a prioritization between the CSI-RS measurement and an overlapped SRS antenna port switching procedure based (at least in part) on a scheduling type of a CSI report for measurement results of the CSI-RS measurement.

Cases where it is determined to prioritize a CSI-RS measurement over an SRS antenna port switching procedure as will be described for the second option may reflect the idea that if a CSI report for measurement results for the CSI-RS measurement has an aperiodic scheduling type, it may not be able to be performed at a later time (because no such time is inherently available corresponding to such aperiodic use). Further, if it is (also) the case that the SRS antenna port switching procedure is of a scheduling type that is periodic or semi-persistent, it is likely that a subsequent opportunity for it will arise. In view of these considerations, the CSI-RS measurement reported by the CSI report for measurement results for the CSI-RS measurement that is of an aperiodic scheduling type may prioritized.

In cases according to the second option where both a scheduling type of a CSI report for measurement results for the CSI-RS measurement is aperiodic and a scheduling type of the SRS transmission of the SRS antenna port switching procedure is aperiodic, the UE may be (pre)configured to prioritize either the CSI-RS measurement or the SRS antenna port switching procedure, or it may prioritize one of the CSI-RS measurement and the SRS antenna port switching procedure according to a dynamic network indication.

In a first case of the second option, it may be that a scheduling type of a CSI report for a CSI measurement is periodic or semi-persistent. A scheduling type of a CSI-RS measurement reported by the CSI report may be periodic or semi-persistent (where a periodic scheduling type for the CSI-RS measurement is possible in the case where the CSI report has a periodic scheduling type). Further, a scheduling type of the SRS transmission of the overlapped SRS antenna port switching procedure is any of periodic, semi-persistent, or aperiodic. In this first case, the UE would prioritize the SRS antenna port switching procedure over the CSI-RS measurement. Accordingly, the UE would perform the SRS antenna port switching procedure and disable the CSI-RS measurement.

In a second case of the second option, it may be that a scheduling type of a CSI report for a CSI measurement is aperiodic. A scheduling type of a CSI-RS measurement reported by the CSI report may be any of periodic, semi-persistent or aperiodic. Finally, a scheduling type of the SRS transmission of the overlapped SRS antenna port switching procedure may be either periodic or semi-persistent. In this second case, the UTE would prioritize the CSI-RS measurement over the SRS antenna port switching procedure. Accordingly, the UE would perform the CSI-RS measurement and disable the SRS antenna port switching procedure.

In a third case of the second option, it may be that a scheduling type of a CSI report for a CSI measurement is aperiodic. A scheduling type of a CSI-RS measurement reported by the CSI report may be any of periodic, semi-persistent, or aperiodic. Finally, a scheduling type of the SRS transmission of the overlapped SRS antenna port switching procedure may be aperiodic.

In a first alternative of this third case, the UE would prioritize the SRS antenna port switching procedure over the CSI-RS measurement. Accordingly, the UTE would perform the SRS antenna port switching procedure and disable the CSI-RS measurement.

In a second alternative of this third case, the UE would prioritize the CSI-RS measurement over the SRS antenna port switching procedure. Accordingly, the UE would perform the CSI-RS measurement and disable the SRS antenna port switching procedure.

In a third alternative of this third case, it may be that the IE determines to prioritize either the CSI-RS measurement or the SRS antenna port switching procedure based on a network indication (e.g., provided from a base station). The UE would then perform the prioritized one of the CSI-RS measurement and the SRS antenna port switching procedure and disable the non-prioritized one of the CSI-RS measurement and the SRS antenna port switching procedure. The network indication may be received in one of DCI, a MAC CE, or RRC signaling.

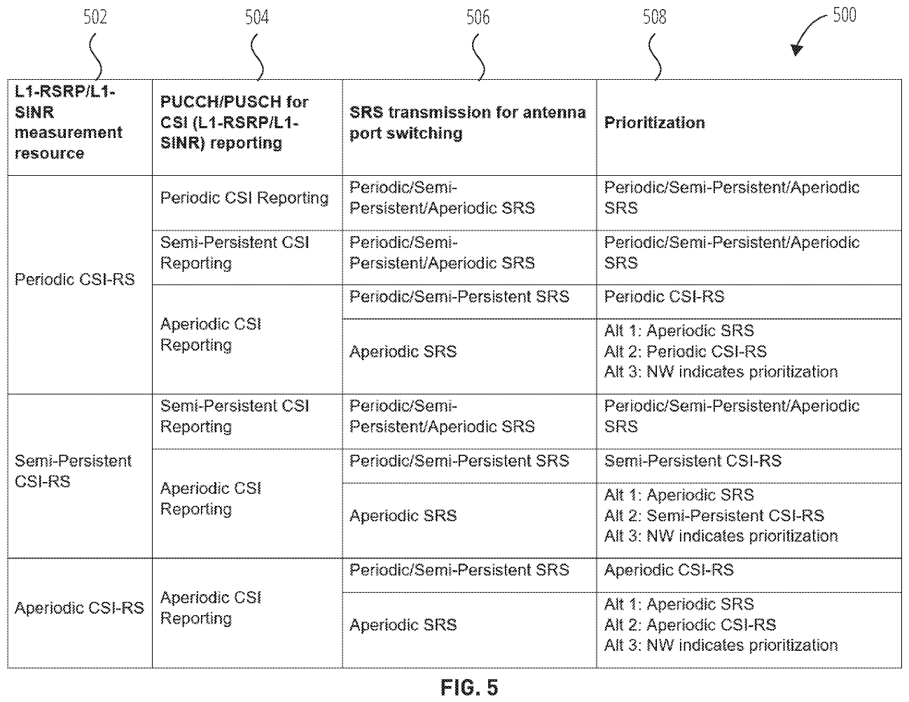

FIG. 5 illustrates a table 500 summarizing various possible prioritizations 508 according to possible combinations of scheduling types for a CSI-RS measurement 502, scheduling types for a CSI report 504, and scheduling types for an SRS transmission 506 when applying the second option, as these have been described above.

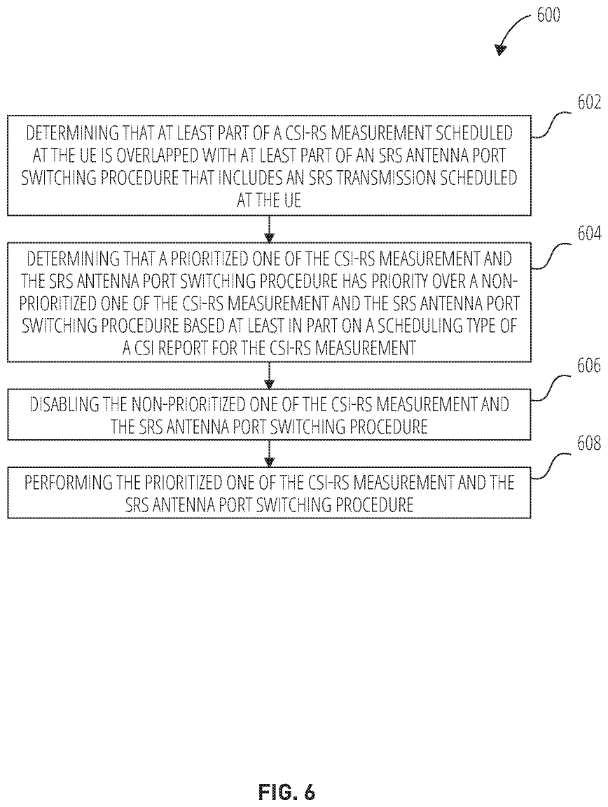

FIG. 6 illustrates a method 600 of a UE, according to an embodiment. The method 600 includes determining 602 that at least part of a CSI-RS measurement scheduled at the UE is overlapped with at least part of an SRS antenna port switching procedure that includes an SRS transmission scheduled at the UE.

The method 600 further includes determining 604 that a prioritized one of the CSI-RS measurement and the SRS antenna port switching procedure has priority over a non-prioritized one of the CSI-RS measurement and the SRS antenna port switching procedure based at least in part on a scheduling type of a CSI report for the CSI-RS measurement.

The method 600 further includes disabling 606 the non-prioritized one of the CSI-RS measurement and the SRS antenna port switching procedure.

The method 600 further includes performing 608 the prioritized one of the CSI-RS measurement and the SRS antenna port switching procedure.

In some embodiments of the method 600, the UE determines that the SRS antenna port switching procedure is the prioritized one when the scheduling type of the CSI report is one of periodic and semi-persistent and a scheduling type of the CSI-RS measurement is one of periodic and semi-persistent.

In some embodiments of the method 600, the UE determines that the CSI-RS measurement is the prioritized one when the scheduling type of the CSI report is aperiodic, a scheduling type of the CSI-RS measurement is one of periodic and semi-persistent, and a scheduling type of the SRS transmission is one of periodic and semi-persistent.

In some embodiments of the method 600, the UE determines that the SRS antenna port switching procedure is the prioritized one when the scheduling type of the CSI report is aperiodic, a scheduling type of the CSI-RS measurement is one of periodic and semi-persistent, and a scheduling type of the SRS transmission is aperiodic.

In some embodiments of the method 600, the UE determines that the CSI-RS measurement is the prioritized one when the scheduling type of the CSI report is aperiodic, a scheduling type of the CSI-RS measurement is one of periodic and semi-persistent, and a scheduling type of the SRS transmission is aperiodic.

In some embodiments of the method 600, the UE determines the prioritized one of the CSI-RS measurement and the SRS antenna port switching procedure according to a network indication when the scheduling type of the CSI report is aperiodic, a scheduling type of the CSI-RS measurement is one of periodic and semi-persistent, and a scheduling type of the SRS transmission is aperiodic. In some of these embodiments, the network indication is provided in one of DCI, a MAC CE, and RRC signaling.

In some embodiments of the method 600, the UE determines that the CSI-RS measurement is the prioritized one when the scheduling type of the CSI report is aperiodic, and a scheduling type of the CSI-RS measurement is aperiodic, and a scheduling type of the SRS transmission is one of periodic and semi-persistent.

In some embodiments of the method 600, the UE determines that the SRS antenna port switching procedure is the prioritized one when the scheduling type of the CSI report is aperiodic, and a scheduling type of the CSI-RS measurement is aperiodic, and a scheduling type of the SRS transmission is aperiodic.

In some embodiments of the method 600, the UE determines that the CSI-RS measurement is the prioritized one when the scheduling type of the CSI report is aperiodic, and a scheduling type of the CSI-RS measurement is aperiodic, and a scheduling type of the SRS transmission is aperiodic.

In some embodiments of the method 600, the UE determines the prioritized one of the CSI-RS measurement and the SRS antenna port switching procedure according to a network indication when the scheduling type of the CSI report is aperiodic, a scheduling type of the CSI-RS measurement is aperiodic, and a scheduling type of the SRS transmission is aperiodic. In some of these embodiments, the network indication is provided in one of DCI, a MAC CE, and RRC signaling.

In some embodiments of the method 600, the SRS antenna port switching procedure further includes one or more transient periods for performing antenna port switching.

In some embodiments of the method 600, the CSI report is scheduled to be sent in one of a PUCCH and a PUSCH.

In some embodiments of the method 600, the CSI-RS measurement comprises one of an L1-RSRP measurement and an L1-SINR measurement.

In some embodiments of the method 600, the CSI-RS measurement and the SRS transmission are for a same carrier.

In some embodiments of the method 600, the SRS transmission is for a first carrier and the CSI-RS measurement is for a second carrier, and wherein a cross-carrier impact parameter indicates that a use of the first carrier for the SRS transmission impacts an ability of the UE to use the second carrier for DL reception. In some of these embodiments, the first carrier and the second carrier are in a same cell group. In some of these embodiments, the first carrier is in a first cell group and the second carrier is in a second cell group.

Embodiments contemplated herein include an apparatus comprising means to perform one or more elements of the method 600. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 600. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 1702 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

A third option for selecting a prioritized one of a measurement and an SRS antenna port switching procedure is now described. The third option contemplates that the measurement is a CSI-RS measurement. The third option determines a prioritization between the CSI-RS measurement and an overlapped SRS antenna port switching procedure based (at least in part) on both a scheduling type of the CSI-RS and a scheduling type of the CSI report for measurement results of the CSI-RS measurement.

Cases where it is determined to prioritize a CSI-RS measurement over an SRS antenna port switching procedure as will be described for the third option may reflect the idea that if either a CSI-RS measurement or a CSI report for measurement results for the CSI-RS measurement has an aperiodic scheduling type, it may not be able to be performed at a later time (because no such time is inherently available corresponding to such aperiodic use). Accordingly, if it is the case that either the CSI-RS measurement and/or a CSI report for measurement results for the CSI-RS measurement is of a scheduling type that is aperiodic, and that the SRS transmission for the overlapping SRS antenna port switching procedure is of a scheduling type that is periodic or semi-persistent (meaning that a subsequent opportunity for the SRS transmission may occur), the UE may prioritize the CSI-RS measurement.

In cases according to the third option where both 1) at least one of a scheduling type of the CSI-RS measurement and a scheduling type of a CSI report for measurement results for the CSI-RS measurement is aperiodic and 2) the scheduling type for the SRS transmission of the SRS antenna port switching procedure is aperiodic, the IE may be (pre)configured to prioritize either the CSI-RS measurement or the SRS antenna port switching procedure, or it may prioritize one of the CSI-RS measurement and the SRS antenna port switching procedure according to a dynamic network indication.

In a first case of the third option, it may be that a scheduling type of a CSI-RS measurement may be periodic or semi-persistent. A scheduling type of a CSI report for measurement results for the CSI measurement is periodic or semi-persistent. Further, a scheduling type of the SRS transmission of the overlapped SRS antenna port switching procedure is any of periodic, semi-persistent, or aperiodic. In this first case, the UE would prioritize the SRS antenna port switching procedure over the CSI-RS measurement. Accordingly, the UE would perform the SRS antenna port switching procedure and disable the CSI-RS measurement.

In a second case of the third option, it may be that either a scheduling type of a CSI-RS measurement is aperiodic or a scheduling type of a CSI report for measurement results for the CSI measurement is aperiodic. Further, a scheduling type of the SRS transmission of the overlapped SRS antenna port switching procedure is periodic or semi-persistent. In this second case, the IE would prioritize the CSI-RS measurement over the SRS antenna port switching procedure. Accordingly, the UE would perform the CSI-RS measurement and disable the SRS antenna port switching procedure.

In a third case of the third option, it may be that either a scheduling type of a CSI-RS measurement is aperiodic or a scheduling type of a CSI report for measurement results for the CSI measurement is aperiodic. Further, a scheduling type of the SRS transmission of the overlapped SRS antenna port switching procedure is aperiodic.

In a first alternative of this third case, the UE would prioritize the SRS antenna port switching procedure over the CSI-RS measurement. Accordingly, the UE would perform the SRS antenna port switching procedure and disable the CSI-RS measurement.

In a second alternative of this third case, the UE would prioritize the CSI-RS measurement over the SRS antenna port switching procedure. Accordingly, the UE would perform the CSI-RS measurement and disable the SRS antenna port switching procedure.

In a third alternative of this third case, it may be that the UE determines to prioritize either the CSI-RS measurement or the SRS antenna port switching procedure based on a network indication (e.g., provided from a base station). The UE would then perform the prioritized one of the CSI-RS measurement and the SRS antenna port switching procedure and disable the non-prioritized one of the CSI-RS measurement and the SRS antenna port switching procedure. The network indication may be received in one of DCI, a MAC CE, or RRC signaling.

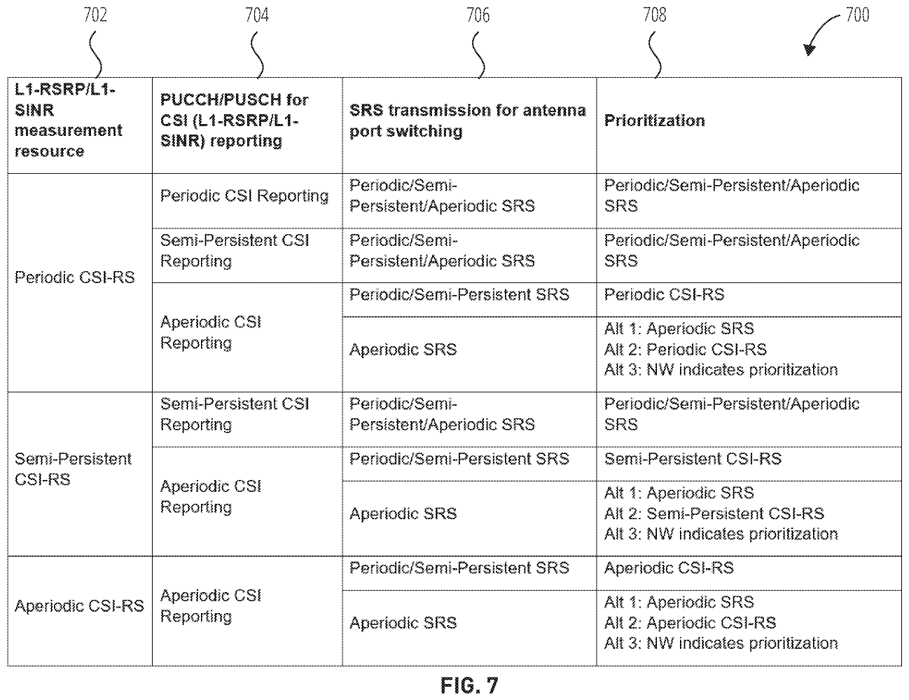

FIG. 7 illustrates a table 700 summarizing various possible prioritizations 708 according to possible combinations of scheduling types for a CSI-RS measurement 702, scheduling types for a CSI report 704, and scheduling types for an SRS transmission 706 when applying the third option, as these have been described above.

A fourth option for selecting a prioritized one of a measurement and an SRS antenna port switching procedure is now described. The fourth option contemplates that the measurement is a CSI-RS measurement. The fourth option determines a prioritization between the CSI-RS measurement and an overlapped SRS antenna port switching procedure based (at least in part) on both a scheduling type of the CSI-RS and a scheduling type of the CSI report for measurement results of the CSI-RS measurement.

Under the fourth option, the UE may be configured to prioritize a CSI-RS measurement in at least some cases where both the CSI-RS measurement has a scheduling type that is aperiodic and the CSI report having a measurement result for the CSI-RS measurement has a scheduling type that is aperiodic. Accordingly, if it is the case that both of the CSI-RS measurement and a CSI report for measurement results for the CSI-RS measurement are (each) of a scheduling type that is aperiodic, and that the SRS transmission for the overlapping SRS antenna port switching procedure is of a scheduling type that is periodic or semi-persistent (meaning that a subsequent opportunity for the SRS transmission may occur), the UTE may prioritize the CSI-RS measurement.

In cases according to the fourth option where a scheduling type of the CSI-RS measurement is aperiodic, a scheduling type of a CSI report for measurement results for the CSI-RS measurement is aperiodic, and a scheduling type for the SRS transmission of the SRS antenna port switching procedure is aperiodic, the UE may be (pre)configured to prioritize either the CSI-RS measurement or the SRS antenna port switching procedure, or it may prioritize one of the CSI-RS measurement and the SRS antenna port switching procedure according to a dynamic network indication.

In a first case of the fourth option, it may be that each of a scheduling type of a CSI-RS measurement and a scheduling type of a CSI report for measurement results for the CSI measurement are aperiodic. Further, a scheduling type of the SRS transmission of the overlapped SRS antenna port switching procedure is periodic or semi-persistent. In this first case, the UE would prioritize the CSI-RS measurement over the SRS antenna port switching procedure. Accordingly, the UE would perform the CSI-RS measurement and disable the SRS antenna port switching procedure.

In a second case of the fourth option, it may be that each of a scheduling type of a CSI-RS measurement and a scheduling type of a CSI report for measurement results for the CSI measurement are aperiodic. Further, a scheduling type of the SRS transmission of the overlapped SRS antenna port switching procedure is also aperiodic.

In a first alternative of this second case, the UE would prioritize the SRS antenna port switching procedure over the CSI-RS measurement. Accordingly, the UE would perform the SRS antenna port switching procedure and disable the CSI-RS measurement.

In a second alternative of this second case, the UE would prioritize the CSI-RS measurement over the SRS antenna port switching procedure. Accordingly, the UE would perform the CSI-RS measurement and disable the SRS antenna port switching procedure.

In a third alternative of this second case, it may be that the UE determines to prioritize either the CSI-RS measurement or the SRS antenna port switching procedure based on a network indication (e.g., provided from a base station). The UE would then perform the prioritized one of the CSI-RS measurement and the SRS antenna port switching procedure and disable the non-prioritized one of the CSI-RS measurement and the SRS antenna port switching procedure. The network indication may be received in one of DCI, a MAC CE, or RRC signaling.

In a third case of the fourth option, it may be that a scheduling type of a CSI-RS measurement is periodic or semi-persistent, and/or that a scheduling type of a CSI report for measurement results for the CSI measurement is periodic or semi-persistent. In this third case, the UE would prioritize the SRS antenna port switching procedure over the CSI-RS measurement. Accordingly, the UE would perform the SRS antenna port switching procedure and disable the CSI-RS measurement.

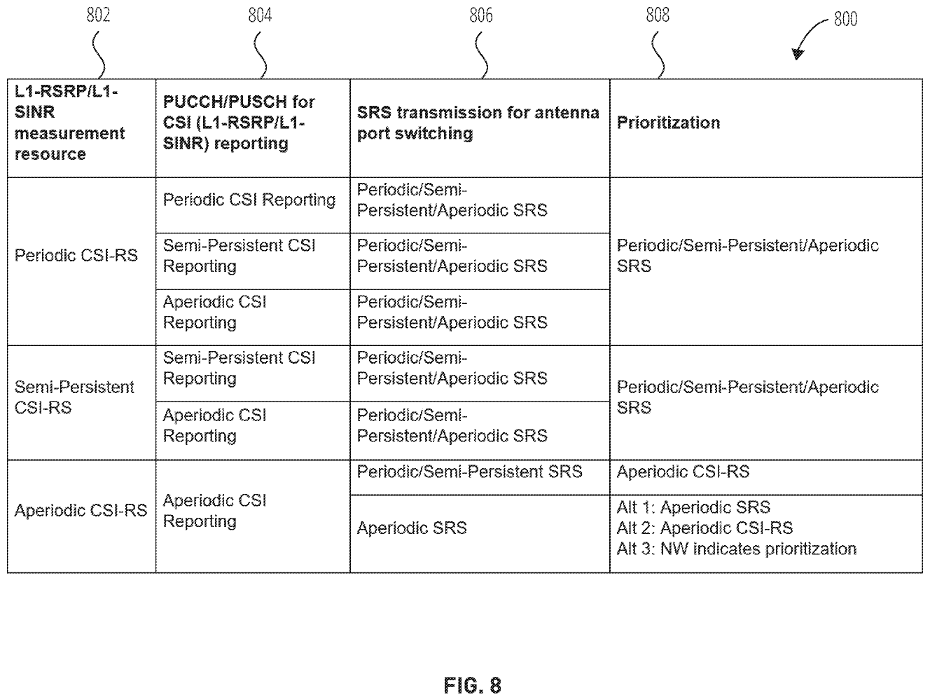

FIG. 8 illustrates a table 800 summarizing various possible prioritizations 808 according to possible combinations of scheduling types for CSI-RS measurement 802, scheduling types for a CSI report 804, and scheduling types for an SRS transmission 806 when applying the fourth option, as these have been described above.

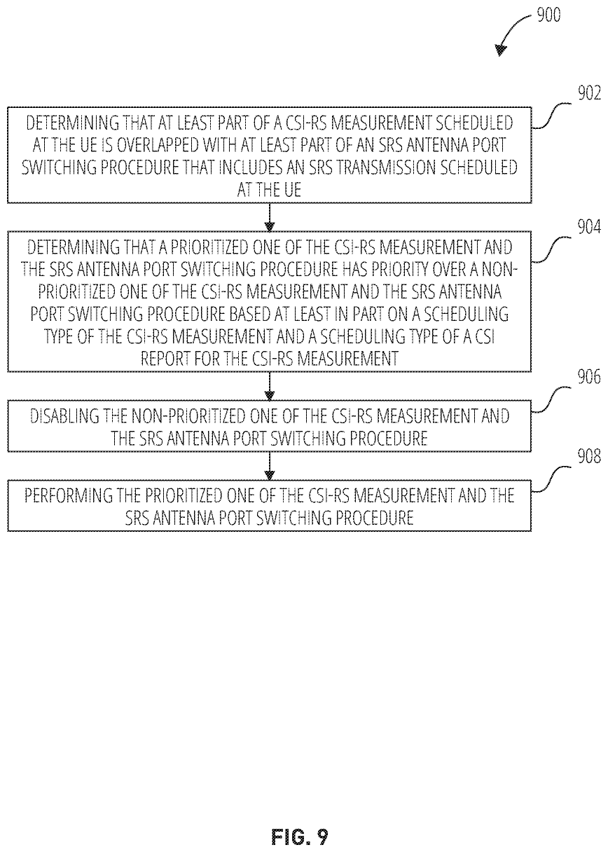

FIG. 9 illustrates a method 900 of a UE, according to an embodiment. The method 900 includes determining 902 that at least part of a CSI-RS measurement scheduled at the UE is overlapped with at least part of an SRS antenna port switching procedure that includes an SRS transmission scheduled at the UE.

The method 900 includes determining 904 that a prioritized one of the CSI-RS measurement and the SRS antenna port switching procedure has priority over a non-prioritized one of the CSI-RS measurement and the SRS antenna port switching procedure based at least in part on a scheduling type of the CSI-RS measurement and a scheduling type of a CSI report for the CSI-RS measurement.

The method 900 further includes disabling 906 the non-prioritized one of the CSI-RS measurement and the SRS antenna port switching procedure.

The method 900 further includes performing 908 the prioritized one of the CSI-RS measurement and the SRS antenna port switching procedure.

In some embodiments of the method 900, the SRS antenna port switching procedure further includes one or more transient periods for performing antenna port switching.

In some embodiments of the method 900, the CSI report is scheduled to be sent in one of a PUCCH and a PUSCH.

In some embodiments of the method 900, the CSI-RS measurement comprises one of an L1-RSRP measurement and an L1-SINR measurement.

In some embodiments of the method 900, the CSI-RS measurement and the SRS transmission are for a same carrier.

In some embodiments of the method 900, the SRS transmission is for a first carrier and the CSI-RS measurement is for a second carrier, and wherein a cross-carrier impact parameter indicates that a use of the first carrier for the SRS transmission impacts an ability of the UE to use the second carrier for DL reception. In some of these embodiments, the first carrier and the second carrier are in a same cell group. In some of these embodiments, the first carrier is in a first cell group and the second carrier is in a second cell group.

Embodiments contemplated herein include an apparatus comprising means to perform one or more elements of the method 900. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 900. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1702 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

A fifth option for selecting a prioritized one of a measurement and an SRS antenna port switching procedure is now described. The fifth option contemplates that the measurement is an SSB measurement. The fifth option may disregard (e.g., not take into account) a scheduling type for a CSI report for the SSB measurement.

Note that due to the inherently periodic nature of SSB reception (and thus any SSB measurement), it may be that a scheduling type for an SSB measurement is treated as periodic. Thus, in the fourth option, it may be that an SRS antenna port switching procedure is prioritized in every circumstance (because, e.g., it is understood that there are follow-up opportunities to perform the SSB measurement, and because the UE may be configured to prioritize the SRS antenna port switching procedure even in the case where an SRS antenna port switching procedure (also) has a scheduling type that is periodic).

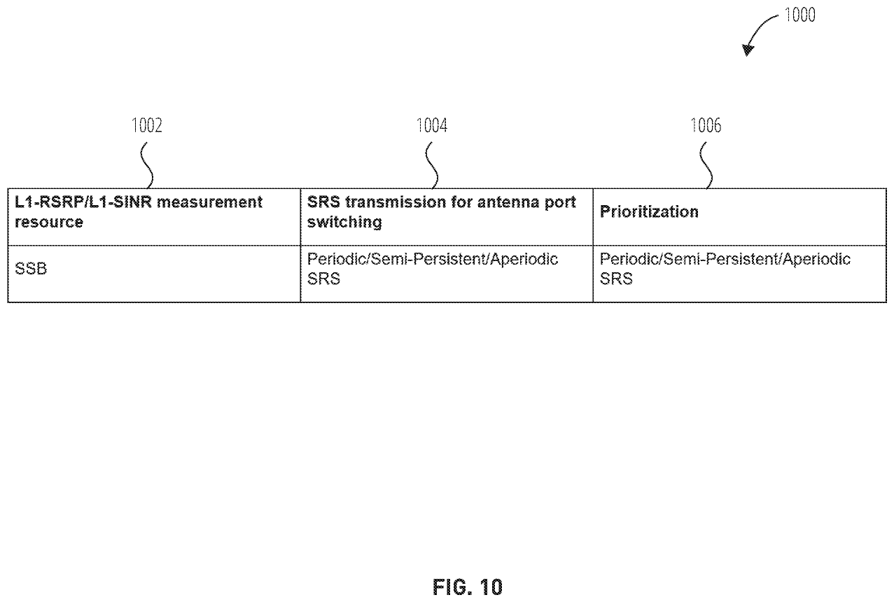

FIG. 10 illustrates a table 1000 summarizing various possible prioritizations 1006 according to possible combinations of an SSB measurement resource 1002 and scheduling types for an SRS transmission 1004 when applying a fifth option, as these have been described above.

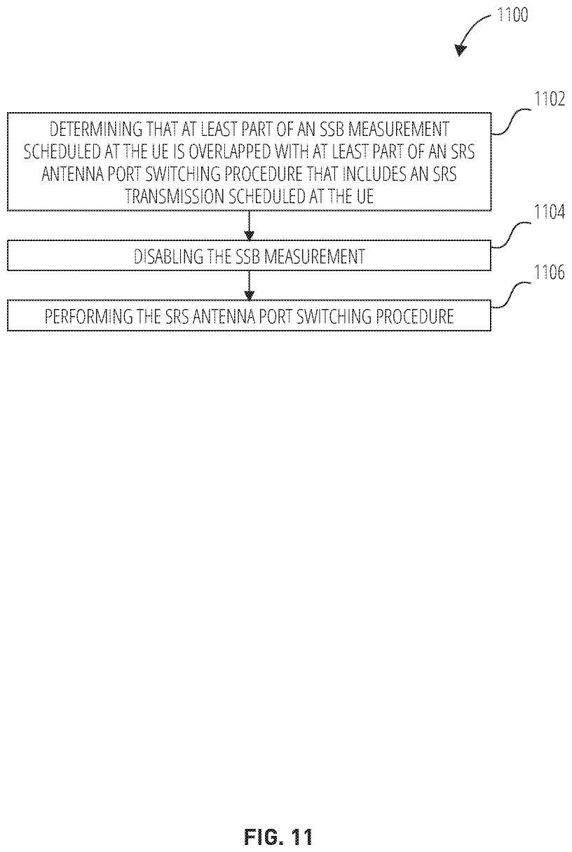

FIG. 11 illustrates a method 1100 of a UE, according to an embodiment. The method 1100 includes determining 1102 that at least part of an SSB measurement scheduled at the UE is overlapped with at least part of an SRS antenna port switching procedure that includes an SRS transmission scheduled at the UE.

The method 1100 further includes disabling 1104 the SSB measurement.

The method 1100 further includes performing 1106 performs the SRS antenna port switching procedure.

In some embodiments of the method 1100, the SRS antenna port switching procedure further includes one or more transient periods for performing antenna port switching.

In some embodiments of the method 1100, a CSI report for the SSB measurement is scheduled to be sent in one of a PUCCH and a PUSCH.

In some embodiments of the method 1100, the SSB measurement comprises one of an L1-RSRP measurement and an L1-SINR measurement.

In some embodiments of the method 1100, the SSB measurement and the SRS transmission are for a same carrier.

In some embodiments of the method 1100, the SRS transmission is for a first carrier and the SSB measurement is for a second carrier, and wherein a cross-carrier impact parameter indicates that a use of the first carrier for the SRS transmission impacts an ability of the UE to use the second carrier for DL reception. In some of these embodiments, the first carrier and the second carrier are in a same cell group. In some of these embodiments, the first carrier is in a first cell group and the second carrier is in a second cell group.

Embodiments contemplated herein include an apparatus comprising means to perform one or more elements of the method 1100. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1100. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1702 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

A sixth option for selecting a prioritized one of a measurement and an SRS antenna port switching procedure is now described. The sixth option contemplates that the measurement is an SSB measurement. The sixth option determines a prioritization between the SSB measurement and an overlapped SRS antenna port switching procedure based (at least in part) on a scheduling type of a CSI report for measurement results of the SSB measurement.

Cases where it is determined to prioritize an SSB measurement over an SRS antenna port switching procedure as will be described for the sixth option may reflect the idea that if a CSI report for measurement results for the SSB measurement has an aperiodic scheduling type, it may not be able to be performed at a later time (because no such time is inherently available corresponding to such aperiodic use). Further, if it is (also) the case that the SRS antenna port switching procedure is of a scheduling type that is periodic or semi-persistent, it is likely that a subsequent opportunity for it will arise. In view of these considerations, the SSB measurement reported by CSI report for measurement results for the SSB measurement that is of an aperiodic scheduling type may prioritized.

In cases according to the sixth option where both a scheduling type of a CSI report for measurement results for the SSB measurement is aperiodic and a scheduling type of the SRS transmission of the SRS antenna port switching procedure is aperiodic, the UE may be (pre)configured to prioritize either the CSI-RS measurement or the SRS antenna port switching procedure, or it may prioritize one of the CSI-RS measurement and the SRS antenna port switching procedure according to a dynamic network indication.

In a first case of the sixth option, it may be that a scheduling type of a CSI report for an SSB measurement is periodic or semi-persistent. Further, a scheduling type of the SRS transmission of the overlapped SRS antenna port switching procedure is any of periodic, semi-persistent, or aperiodic. In this first case, the UE would prioritize the SRS antenna port switching procedure over the SSB measurement. Accordingly, the UE would perform the SRS antenna port switching procedure and disable the SSB measurement.

In a second case of the sixth option, it may be that a scheduling type of a CSI report for an SSB measurement is aperiodic. Further, a scheduling type of the SRS transmission of the overlapped SRS antenna port switching procedure is periodic or semi-persistent. In this second case, the UE would prioritize the SSB measurement over the SRS antenna port switching procedure. Accordingly, the UE would perform the SSB measurement and disable the SRS antenna port switching procedure.

In a third case of the sixth option, it may be that a scheduling type of a CSI report for an SSB measurement is aperiodic. Further, a scheduling type of the SRS transmission of the overlapped SRS antenna port switching procedure may be aperiodic.

In a first alternative of this third case, the UE would prioritize the SRS antenna port switching procedure over the SSB measurement. Accordingly, the UE would perform the SRS antenna port switching procedure and disable the SSB measurement.

In a second alternative of this third case, the UE would prioritize the SSB measurement over the SRS antenna port switching procedure. Accordingly, the UE would perform the SSB measurement and disable the SRS antenna port switching procedure.

In a third alternative of this third case, it may be that the UE determines to prioritize either the SSB measurement or the SRS antenna port switching procedure based on a network indication (e.g., provided from a base station). The UE would then perform the prioritized one of the SSB measurement and the SRS antenna port switching procedure and disable the non-prioritized one of the SSB measurement and the SRS antenna port switching procedure. The network indication may be received in one of DCI, a MAC CE, or RRC signaling.

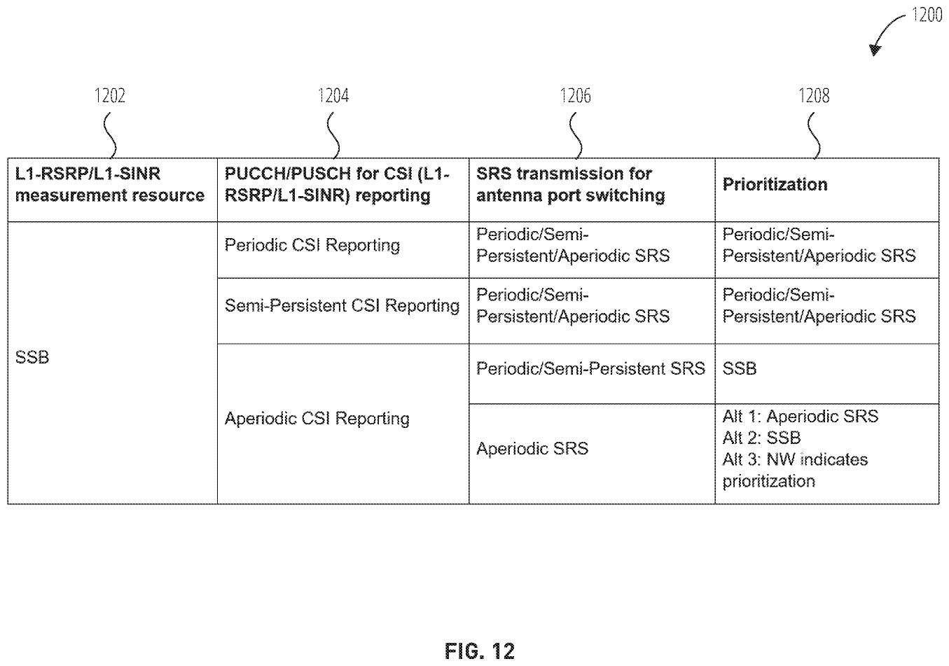

FIG. 12 illustrates a table 1200 summarizing various possible prioritizations 1208 according to possible combinations of an SSB measurement resource 1202, scheduling types for a CSI report 1204, and scheduling types for an SRS transmission 1206 when applying a sixth option, as these have been described above.

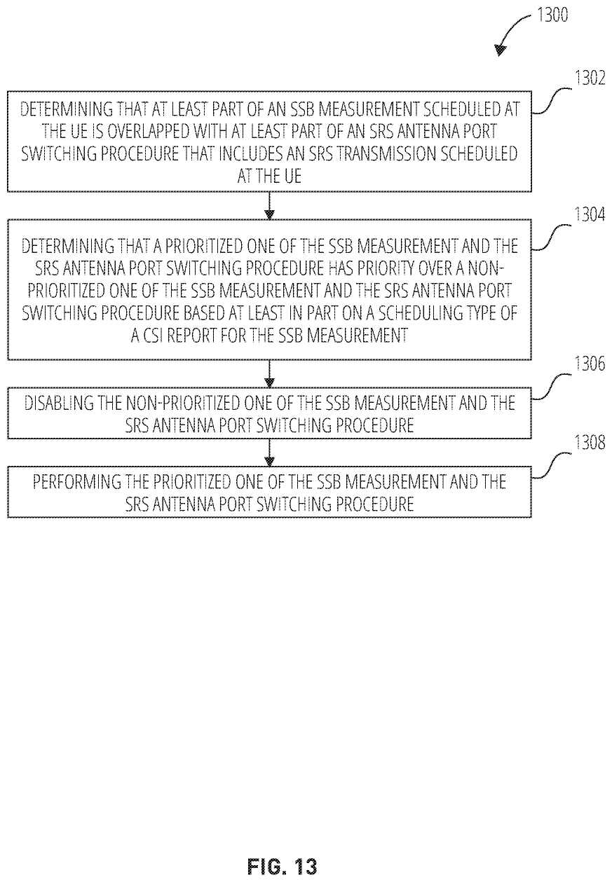

FIG. 13 illustrates a method 1300 of a UE, according to an embodiment. The method 1300 includes determining 1302 that at least part of an SSB measurement scheduled at the UE is overlapped with at least part of an SRS antenna port switching procedure that includes an SRS transmission scheduled at the UE.

The method 1300 further includes determining 1304 that a prioritized one of the SSB measurement and the SRS antenna port switching procedure has priority over a non-prioritized one of the SSB measurement and the SRS antenna port switching procedure based at least in part on a scheduling type of a CSI report for the SSB measurement.

The method 1300 further includes disabling 1306 the non-prioritized one of the SSB measurement and the SRS antenna port switching procedure.

The method 1300 further includes performing 1308 the prioritized one of the SSB measurement and the SRS antenna port switching procedure.

In some embodiments of the method 1300, the SRS antenna port switching procedure further includes one or more transient periods for performing antenna port switching.

In some embodiments of the method 1300, the CSI report is scheduled to be sent in one of a PUCCH and a PUSCH.

In some embodiments of the method 1300, the SSB measurement comprises one of an L1-RSRP measurement and an L1-SINR measurement.

In some embodiments of the method 1300, the SSB measurement and the SRS transmission are for a same carrier.

In some embodiments of the method 1300, the SRS transmission is for a first carrier and the SSB measurement is for a second carrier, and wherein a cross-carrier impact parameter indicates that a use of the first carrier for the SRS transmission impacts an ability of the UE to use the second carrier for DL reception. In some of these embodiments, the first carrier and the second carrier are in a same cell group. In some of these embodiments, the first carrier is in a first cell group and the second carrier is in a second cell group.

Embodiments contemplated herein include an apparatus comprising means to perform one or more elements of the method 1300. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1300. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a UE (such as a wireless device 1702 that is a UE, as described herein).

Embodiments contemplated herein include a signal as described in or related to one or more elements of the method 1300.

Embodiments contemplated herein include a computer program or computer program product comprising instructions, wherein execution of the program by a processor is to cause the processor to carry out one or more elements of the method 1300. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

In some embodiments, it may be that the network is configured to avoid causing an overlap between a measurement and an SRS antenna port switching procedure by accounting for a location of the SRS antenna port switching procedure prior to configuring the measurement (e.g., a CSI-RS measurement and/or an SSB measurement). For example, a network may configure a transmission of a CSI-RS (e.g., for the UE to use to take an L1-RSRP and/or L1-SINR measurement to report) to occur on symbols outside the SRS antenna port switching procedure (e.g., outside of an SRS transmission of the SRS antenna port switching procedure and any transient symbols for port switching that are also part of the SRS antenna port switching procedure). In another example, a network may configure a transmission of an SSB (e.g., for the UE to use to take an L1-RSRP and/or L1-SINR measurement to report) to occur on symbols outside the SRS antenna port switching procedure (e.g., outside of an SRS transmission of the SRS antenna port switching procedure and any transient symbols for port switching that are also part of the SRS antenna port switching procedure).

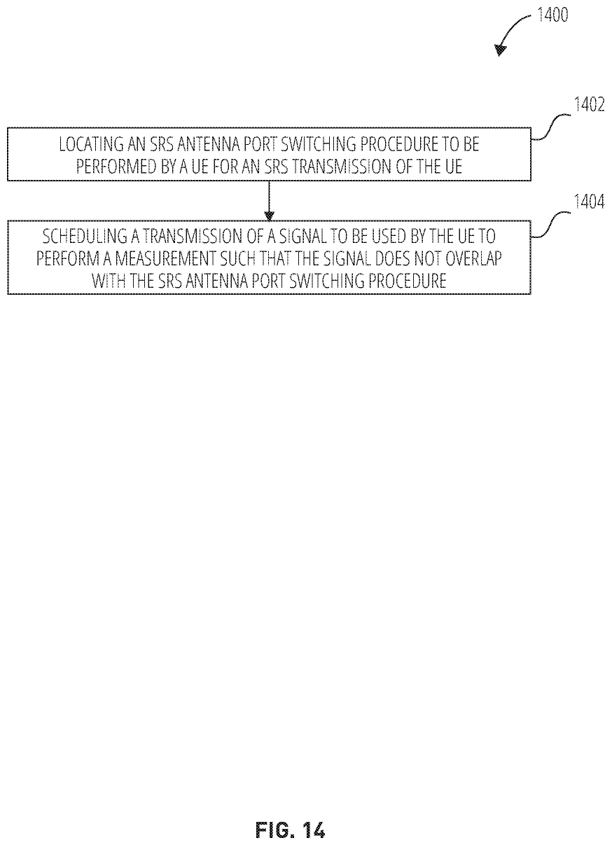

FIG. 14 illustrates a method 1400 of a wireless communication network, according to an embodiment. The method 1400 includes locating 1402 an SRS antenna port switching procedure to be performed by a UE for an SRS transmission of the UE.

The method 1400 further includes scheduling 1404 a transmission of a signal to be used by the UE to perform a measurement such that the signal does not overlap with the SRS antenna port switching procedure.

In some embodiments of the method 1400, the SRS antenna port switching procedure includes the SRS transmission and one or more transient periods for performing antenna port switching.

In some embodiments of the method 1400, the signal for the measurement is one of a CSI-RS and a SSB.

In some embodiments of the method 1400, the measurement comprises one of a L1-RSRP measurement and a L1-SINR measurement.

Embodiments contemplated herein include an apparatus comprising means to perform one or more elements of the method 1400. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1400. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 1400. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1400. This apparatus may be, for example, an apparatus of a base station (such as a network device 1718 that is a base station, as described herein).

Embodiments contemplated herein include a signal as described in or related to one or more elements of the method 1400.

Embodiments contemplated herein include a computer program or computer program product comprising instructions, wherein execution of the program by a processing element is to cause the processing element to carry out one or more elements of the method 1400. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

In some embodiments, it may be that the network is configured to avoid causing an overlap between a measurement an SRS antenna port switching procedure by accounting for a location of a measurement to be performed at the UE (e.g., a CSI-RS measurement and/or an SSB measurement) prior to configuring an SRS transmission that uses an SRS antenna port switching procedure. For example, a network may configure the SRS transmission to occur on symbols outside a CSI-RS measurement at the UE (e.g., an L1-RSRP and/or L1-SINR measurement of the CSI-RS at the UE), outside a symbol prior to the CSI-RS measurement at the UE, and a symbol following the CSI-RS measurement at the UE. Avoiding the symbol prior to the CSI-RS measurement and the symbol after the CSI-RS measurement with the SRS transmission may account/leave additional buffer for any antenna port switching of the SRS antenna port switching procedure of which the SRS transmission is a part. In another example, a network may configure the SRS transmission to occur on symbols outside an SSB measurement at the UE (e.g., an L1-RSRP and/or L1-SINR measurement of an SSB at the UE), outside a symbol prior to the SSB measurement at the UE, and a symbol following the SSB measurement at the UE. Avoiding the symbol prior to the SSB measurement and the symbol after the SSB measurement with the SRS transmission may account/leave additional buffer for any antenna port switching of the SRS antenna port switching procedure of which the SRS transmission is a part.

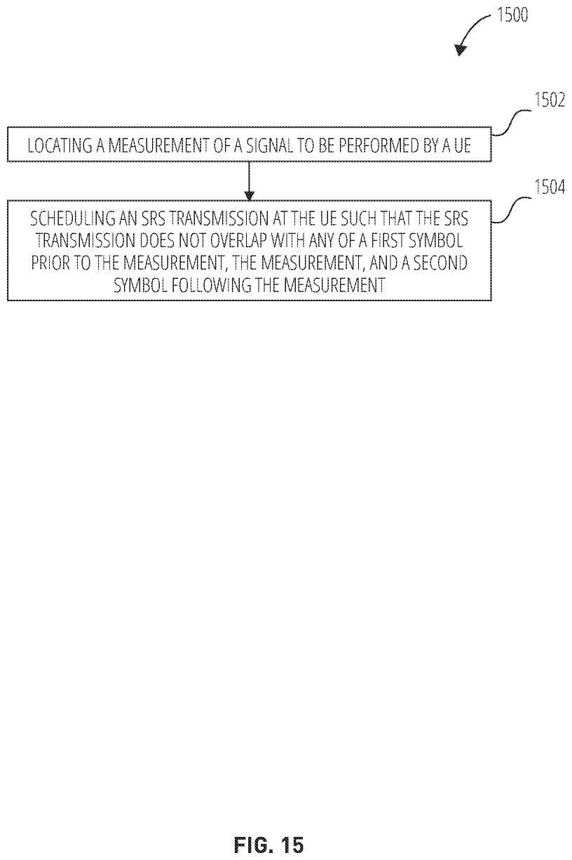

FIG. 15 illustrates a method 1500 of a wireless communication network, according to an embodiment. The method 1500 includes locating 1502 a measurement of a signal to be performed by a UE.

The method 1500 further includes scheduling 1504 an SRS transmission at the UE such that the SRS transmission does not overlap with any of a first symbol prior to the measurement, the measurement, and a second symbol following the measurement.

In some embodiments of the method 1500, the SRS transmission at the UE is part of an SRS antenna port switching procedure performed by the UE that further includes one or more transient periods.

In some embodiments of the method 1500, the signal for the measurement is one of a channel state information reference signal (CSI-RS) and a synchronization signal block (SSB).

In some embodiments of the method 1500, the measurement comprises one of a Layer-1 reference signal received power (L1-RSRP) measurement and a Layer-1 signal to interference and noise ratio (L1-SINR) measurement.

Embodiments contemplated herein include an apparatus comprising means to perform one or more elements of the method 1500. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1500. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 1500. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1500. This apparatus may be, for example, an apparatus of a base station (such as a network device 1718 that is a base station, as described herein).

Embodiments contemplated herein include a signal as described in or related to one or more elements of the method 1500.

Embodiments contemplated herein include a computer program or computer program product comprising instructions, wherein execution of the program by a processing element is to cause the processing element to carry out one or more elements of the method 1500. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

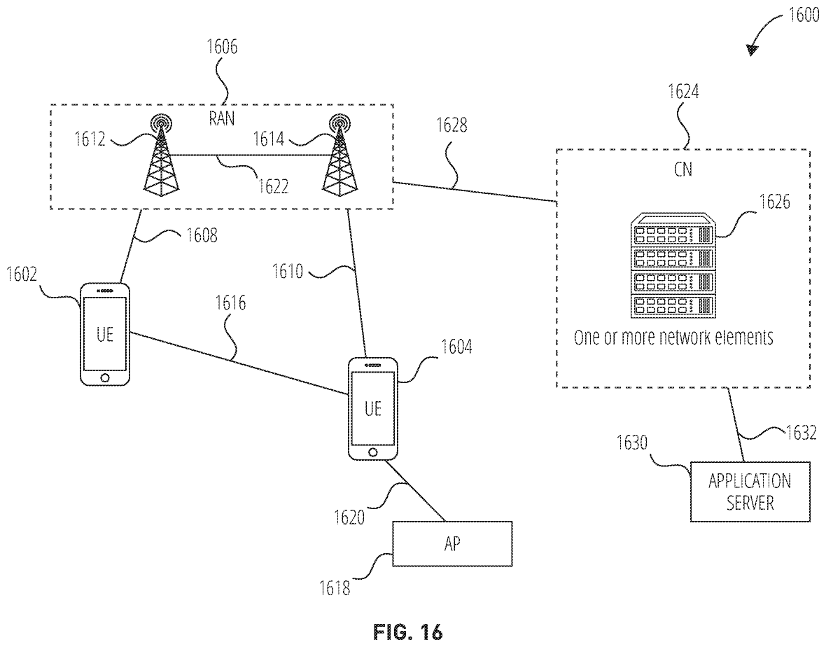

FIG. 16 illustrates an example architecture of a wireless communication system 1600, according to embodiments disclosed herein. The following description is provided for an example wireless communication system 1600 that operates in conjunction with the LTE system standards and/or 5G or NR system standards as provided by 3GPP technical specifications.

As shown by FIG. 16, the wireless communication system 1600 includes UE 1602 and UE 1604 (although any number of UEs may be used). In this example, the UE 1602 and the UE 1604 are illustrated as smartphones (e.g., handheld touchscreen mobile computing devices connectable to one or more cellular networks), but may also comprise any mobile or non-mobile computing device configured for wireless communication.

The UE 1602 and UE 1604 may be configured to communicatively couple with a RAN 1606. In embodiments, the RAN 1606 may be NG-RAN, E-UTRAN, etc. The UE 1602 and UE 1604 utilize connections (or channels) (shown as connection 1608 and connection 1610, respectively) with the RAN 1606, each of which comprises a physical communications interface. The RAN 1606 can include one or more base stations, such as base station 1612 and base station 1614, that enable the connection 1608 and connection 1610.

In this example, the connection 1608 and connection 1610 are air interfaces to enable such communicative coupling, and may be consistent with RAT(s) used by the RAN 1606, such as, for example, an LTE and/or NR.

In some embodiments, the UE 1602 and UE 1604 may also directly exchange communication data via a sidelink interface 1616. The UE 1604 is shown to be configured to access an access point (shown as AP 1618) via connection 1620. By way of example, the connection 1620 can comprise a local wireless connection, such as a connection consistent with any IEEE 602.11 protocol, wherein the AP 1618 may comprise a Wi-Fi® router. In this example, the AP 1618 may be connected to another network (for example, the Internet) without going through a CN 1624.

In embodiments, the UE 1602 and UE 1604 can be configured to communicate using orthogonal frequency division multiplexing (OFDM) communication signals with each other or with the base station 1612 and/or the base station 1614 over a multicarrier communication channel in accordance with various communication techniques, such as, but not limited to, an orthogonal frequency division multiple access (OFDMA) communication technique (e.g., for DL communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1612 or base station 1614 may be implemented as one or more software entities running on server computers as part of a virtual network. In addition, or in other embodiments, the base station 1612 or base station 1614 may be configured to communicate with one another via interface 1622. In embodiments where the wireless communication system 1600 is an LTE system (e.g., when the CN 1624 is an EPC), the interface 1622 may be an X2 interface. The X2 interface may be defined between two or more base stations (e.g., two or more eNBs and the like) that connect to an EPC, and/or between two eNBs connecting to the EPC. In embodiments where the wireless communication system 1600 is an NR system (e.g., when CN 1624 is a 5GC), the interface 1622 may be an Xn interface. The Xn interface is defined between two or more base stations (e.g., two or more gNBs and the like) that connect to 5GC, between a base station 1612 (e.g., a gNB) connecting to 5GC and an eNB, and/or between two eNBs connecting to 5GC (e.g., CN 1624).

The RAN 1606 is shown to be communicatively coupled to the CN 1624. The CN 1624 may comprise one or more network elements 1626, which are configured to offer various data and telecommunications services to customers/subscribers (e.g., users of UE 1602 and UE 1604) who are connected to the CN 1624 via the RAN 1606. The components of the CN 1624 may be implemented in one physical device or separate physical devices including components to read and execute instructions from a machine-readable or computer-readable medium (e.g., a non-transitory machine-readable storage medium).

In embodiments, the CN 1624 may be an EPC, and the RAN 1606 may be connected with the CN 1624 via an S1 interface 1628. In embodiments, the S1 interface 1628 may be split into two parts, an S1 user plane (S1-U) interface, which carries traffic data between the base station 1612 or base station 1614 and a serving gateway (S-GW), and the S1-MME interface, which is a signaling interface between the base station 1612 or base station 1614 and mobility management entities (MMEs).

In embodiments, the CN 1624 may be a 5GC, and the RAN 1606 may be connected with the CN 1624 via an NG interface 1628. In embodiments, the NG interface 1628 may be split into two parts, an NG user plane (NG-U) interface, which carries traffic data between the base station 1612 or base station 1614 and a user plane function (UPF), and the S1 control plane (NG-C) interface, which is a signaling interface between the base station 1612 or base station 1614 and access and mobility management functions (AMFs).

Generally, an application server 1630 may be an element offering applications that use internet protocol (IP) bearer resources with the CN 1624 (e.g., packet switched data services). The application server 1630 can also be configured to support one or more communication services (e.g., VoIP sessions, group communication sessions, etc.) for the UE 1602 and IE 1604 via the CN 1624. The application server 1630 may communicate with the CN 1624 through an IP communications interface 1632.

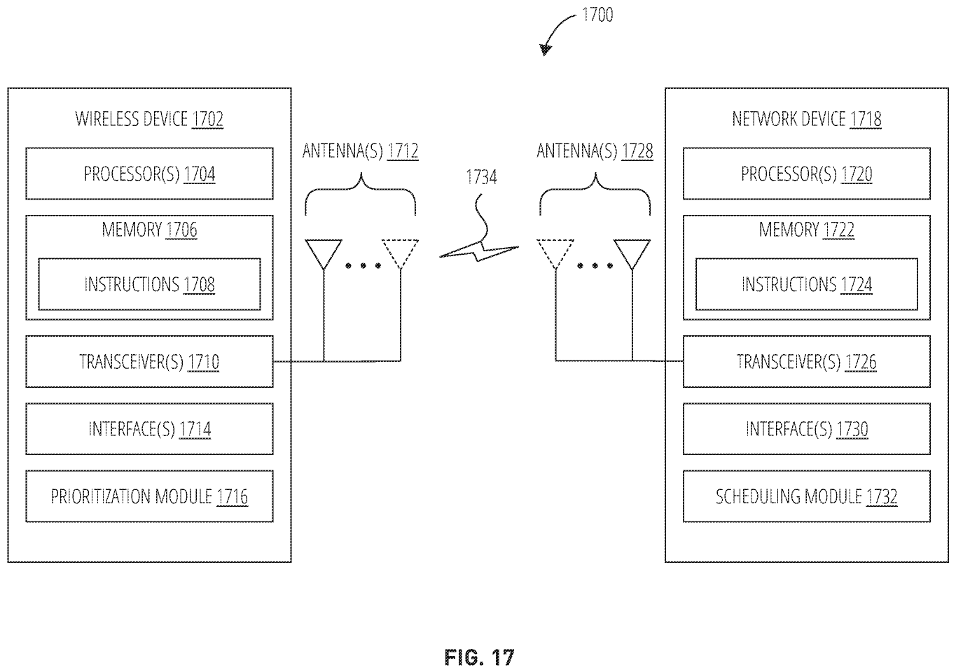

FIG. 17 illustrates a system 1700 for performing signaling 1734 between a wireless device 1702 and a network device 1718, according to embodiments disclosed herein. The system 1700 may be a portion of a wireless communications system as herein described. The wireless device 1702 may be, for example, a UE of a wireless communication system. The network device 1718 may be, for example, a base station (e.g., an eNB or a gNB) of a wireless communication system.

The wireless device 1702 may include one or more processor(s) 1704. The processor(s) 1704 may execute instructions such that various operations of the wireless device 1702 are performed, as described herein. The processor(s) 1704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1702 may include a memory 1706. The memory 1706 may be a non-transitory computer-readable storage medium that stores instructions 1708 (which may include, for example, the instructions being executed by the processor(s) 1704). The instructions 1708 may also be referred to as program code or a computer program. The memory 1706 may also store data used by, and results computed by, the processor(s) 1704.

The wireless device 1702 may include one or more transceiver(s) 1710 that may include radio frequency (RF) transmitter and/or receiver circuitry that use the antenna(s) 1712 of the wireless device 1702 to facilitate signaling (e.g., the signaling 1734) to and/or from the wireless device 1702 with other devices (e.g., the network device 1718) according to corresponding RATs.

The wireless device 1702 may include one or more antenna(s) 1712 (e.g., one, two, four, or more). For embodiments with multiple antenna(s) 1712, the wireless device 1702 may leverage the spatial diversity of such multiple antenna(s) 1712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1702 may be accomplished according to precoding (or digital beamforming) that is applied at the wireless device 1702 that multiplexes the data streams across the antenna(s) 1712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1702 may implement analog beamforming techniques, whereby phases of the signals sent by the antenna(s) 1712 are relatively adjusted such that the (joint) transmission of the antenna(s) 1712 can be directed (this is sometimes referred to as beam steering).

The wireless device 1702 may include one or more interface(s) 1714. The interface(s) 1714 may be used to provide input to or output from the wireless device 1702. For example, a wireless device 1702 that is a UE may include interface(s) 1714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1710/antenna(s) 1712 already described) that allow for communication between the UE and other devices and may operate according to known protocols (e.g., Wi-Fi®, Bluetooth®, and the like).

The wireless device 1702 may include a prioritization module 1716. The prioritization module 1716 may be implemented via hardware, software, or combinations thereof. For example, the prioritization module 1716 may be implemented as a processor, circuit, and/or instructions 1708 stored in the memory 1706 and executed by the processor(s) 1704. In some examples, the prioritization module 1716 may be integrated within the processor(s) 1704 and/or the transceiver(s) 1710. For example, the prioritization module 1716 may be implemented by a combination of software components (e.g., executed by a DSP or a general processor) and hardware components (e.g., logic gates and circuitry) within the processor(s) 1704 or the transceiver(s) 1710.

The prioritization module 1716 may be used for various aspects of the present disclosure, for example, aspects of FIG. 3 through FIG. 13. The prioritization module 1716 may configure the UE to prioritize one of an SRS antenna port switching procedure having an SRS transmission and a signal measurement (e.g., a measurement of an CSI-RS or an SSB), according to one of the options discussed herein.

The network device 1718 may include one or more processor(s) 1720. The processor(s) 1720 may execute instructions such that various operations of the network device 1718 are performed, as described herein. The processor(s) 1720 may include one or more baseband processors implemented using, for example, a CPU, a DSP, an ASIC, a controller, an FPGA device, another hardware device, a firmware device, or any combination thereof configured to perform the operations described herein.

The network device 1718 may include a memory 1722. The memory 1722 may be a non-transitory computer-readable storage medium that stores instructions 1724 (which may include, for example, the instructions being executed by the processor(s) 1720). The instructions 1724 may also be referred to as program code or a computer program. The memory 1722 may also store data used by, and results computed by, the processor(s) 1720.

The network device 1718 may include one or more transceiver(s) 1726 that may include RF transmitter and/or receiver circuitry that use the antenna(s) 1728 of the network device 1718 to facilitate signaling (e.g., the signaling 1734) to and/or from the network device 1718 with other devices (e.g., the wireless device 1702) according to corresponding RATs.

The network device 1718 may include one or more antenna(s) 1728 (e.g., one, two, four, or more). In embodiments having multiple antenna(s) 1728, the network device 1718 may perform MIMO, digital beamforming, analog beamforming, beam steering, etc., as has been described.

The network device 1718 may include one or more interface(s) 1730. The interface(s) 1730 may be used to provide input to or output from the network device 1718. For example, a network device 1718 that is a base station may include interface(s) 1730 made up of transmitters, receivers, and other circuitry (e.g., other than the transceiver(s) 1726/antenna(s) 1728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1718 may include a scheduling module 1732. The scheduling module 1732 may be implemented via hardware, software, or combinations thereof. For example, the scheduling module 1732 may be implemented as a processor, circuit, and/or instructions 1724 stored in the memory 1722 and executed by the processor(s) 1720. In some examples, the scheduling module 1732 may be integrated within the processor(s) 1720 and/or the transceiver(s) 1726. For example, the scheduling module 1732 may be implemented by a combination of software components (e.g., executed by a DSP or a general processor) and hardware components (e.g., logic gates and circuitry) within the processor(s) 1720 or the transceiver(s) 1726.

The scheduling module 1732 may be used for various aspects of the present disclosure, for example, aspects of FIG. 14 and FIG. 15. The scheduling module 1732 may configure the network device 1718 to locate an SRS antenna port switching procedure to be performed by a UE (e.g., a wireless device 1702 that is a UE) and schedule a transmission of a signal to be measured (e.g., a CSI-RS or an SSB) outside of the SRS antenna port switching procedure. Alternatively, the scheduling module 1732 may configure the network device 1718 to locate a measurement of a signal (e.g., of a CSI-RS or an SSB) to be performed by a UE (e.g., a wireless device 1702 that is a UE) and schedule an SRS transmission at the UE such that it does not overlap with the measurement, a symbol prior to the measurement, and/or a symbol following the measurement.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining that at least part of a channel state information reference signal (CSI-RS) measurement scheduled at the UE is overlapped with at least part of a sounding reference signal (SRS) antenna port switching procedure that includes an SRS transmission scheduled at the UE;
determining that a prioritized one of the CSI-RS measurement and the SRS antenna port switching procedure has priority over a non-prioritized one of the CSI-RS measurement and the SRS antenna port switching procedure based at least in part on a scheduling type of the CSI-RS measurement;
disabling the non-prioritized one of the CSI-RS measurement and the SRS antenna port switching procedure; and
performing the prioritized one of the CSI-RS measurement and the SRS antenna port switching procedure.

2. The method of claim 1, wherein the UE determines that the SRS antenna port switching procedure is the prioritized one when the scheduling type of the CSI-RS measurement is one of periodic and semi-persistent.

3. The method of claim 1, wherein the UE determines that the CSI-RS measurement is the prioritized one when the scheduling type of the CSI-RS measurement is aperiodic and when a scheduling type of the SRS transmission is one of periodic and semi-persistent.

4. The method of claim 1, wherein the UE determines that the SRS antenna port switching procedure is the prioritized one when the scheduling type of the CSI-RS measurement is aperiodic and a scheduling type of the SRS transmission is aperiodic.

5. The method of claim 1, wherein the UE determines that the CSI-RS measurement is the prioritized one when the scheduling type of the CSI-RS measurement is aperiodic and a scheduling type of the SRS transmission is aperiodic.

6. The method of claim 1, wherein the UE determines the prioritized one of the CSI-RS measurement and the SRS antenna port switching procedure according to a network indication when the scheduling type of the CSI-RS measurement is aperiodic and a scheduling type of the SRS transmission is aperiodic.

7. The method of claim 6, wherein the network indication is provided in one of downlink control information (DCI), a medium access control control element (MAC CE), and radio resource control (RRC) signaling.

8. The method of claim 1, wherein the SRS antenna port switching procedure further includes one or more transient periods for performing antenna port switching.

9. The method of claim 1, wherein a channel state information (CSI) report for the CSI-RS measurement is scheduled to be sent in one of a physical uplink control channel (PUCCH) and a physical uplink shared channel (PUSCH).

10. The method of claim 1, wherein the CSI-RS measurement comprises one of a Layer-1 reference signal received power (L1-RSRP) measurement and a Layer-1 signal to interference and noise ratio (L1-SINR) measurement.

11. The method of claim 1, wherein the CSI-RS measurement and the SRS transmission are for a same carrier.

12. The method of claim 1, wherein the SRS transmission is for a first carrier and the CSI-RS measurement is for a second carrier, and wherein a cross-carrier impact parameter indicates that a use of the first carrier for the SRS transmission impacts an ability of the UE to use the second carrier for downlink (DL) reception.

13. The method of claim 12, wherein the first carrier and the second carrier are in a same cell group.

14. The method of claim 12, wherein the first carrier is in a first cell group and the second carrier is in a second cell group.

15. A method of a user equipment (UE), comprising:
determining that at least part of a channel state information reference signal (CSI-RS) measurement scheduled at the UE is overlapped with at least part of a sounding reference signal (SRS) antenna port switching procedure that includes an SRS transmission scheduled at the UE;
determining that a prioritized one of the CSI-RS measurement and the SRS antenna port switching procedure has priority over a non-prioritized one of the CSI-RS measurement and the SRS antenna port switching procedure based at least in part on a scheduling type of a channel state information (CSI) report for the CSI-RS measurement;
disabling the non-prioritized one of the CSI-RS measurement and the SRS antenna port switching procedure; and
performing the prioritized one of the CSI-RS measurement and the SRS antenna port switching procedure.

16. The method of claim 15, wherein the UE determines that the SRS antenna port switching procedure is the prioritized one when the scheduling type of the CSI report is one of periodic and semi-persistent, a scheduling type of the CSI-RS measurement is one of periodic and semi-persistent, and a scheduling type of the SRS transmission is one of periodic, semi-persistent, and aperiodic.

17-23. (canceled)

24. A method of a wireless communication network, comprising:
locating a sounding reference signal (SRS) antenna port switching procedure to be performed by a UE for an SRS transmission of the UE; and
scheduling a transmission of a signal to be used by the UE to perform a measurement such that the signal does not overlap with the SRS antenna port switching procedure.

25. The method of claim 24, wherein the SRS antenna port switching procedure includes the SRS transmission and one or more transient periods for performing antenna port switching.

26. The method of claim 24, wherein the signal for the measurement is one of a channel state information reference signal (CSI-RS) and a synchronization signal block (SSB).

27. The method of claim 24, wherein the measurement comprises one of a Layer-1 reference signal received power (L1-RSRP) measurement and a Layer-1 signal to interference and noise ratio (L1-SINR) measurement.

28-35. (canceled)
